(19) United States
(12) Patent Application Publication
(10) Pub. No.: US 2012/0162816 A1
(43) Pub. Date: Jun. 28, 2012

(54) AIRFLOW SHROUD THAT REDUCES VIBRATION OF A ROTATING DISK IN A HARD DISK DRIVE

(76) Inventors: Jiro Kaneko, Kanagawa (JP); Naoshi Mizumoto, Kanagawa (JP); Takeshi Chawanya, Kanagawa (JP); Takashi Kouno, Ibaraki (JP)

(21) Appl. No.: 12/978,886

(22) Filed: Dec. 27, 2010

(51) Int. Cl. G11B 33/14

(52) U.S. Cl. 360/97.14; G9B/33.048

(57) ABSTRACT

A hard disk drive including a base portion, a motor-hub assembly to which at least one disk is coupled, the motor-hub assembly coupled with the base portion and an airflow shroud coupled with the base portion. The airflow shroud including an airflow inlet oriented parallel to the disk and an airflow outlet oriented perpendicular to the disk. In so doing, the airflow shroud reduces vibration of a rotating disk in a hard disk drive.

### BACKGROUND

In hard disk drive operation, it is important to filter airflow while keeping the circulation of the air as smooth as possible. Anytime the airflow is disturbed vibration of one or more components within the hard disk drive can occur. The overall effect of the disturbance may be dependent upon the size of the airflow disruption as well as the size of the component being vibrated.

As hard disk drives and the associated components are reduced in size, vibration of the smaller components is more easily achieved. For example, as a component is reduced in size, less force is required to instill a deleterious vibration.

Similarly, as revolutions per minute (RPM) increase in hard disk drive operation, airflow disturbances may gain a greater strength or force. For example, components of similar size would be more detrimentally affected by disruptions in airflow at 15,000 RPM versus 5000 RPM.

Thus, as hard disk drives are reduced in size, provided with higher RPM operations, or a combination thereof, the deleterious effects of airflow disturbances are magnified. In other words, an airflow disturbance that may have been within tolerances in a hard disk drive designed for operation at 5000 RPM may cause out of tolerance operation when operated at 7500 or more RPM. Similarly, a component at an initial size may have been within tolerances with respect to an airflow disturbance. However, at a reduced size, the component may not be able to encounter a similar airflow disturbance and remain within operational tolerances.

### SUMMARY

A hard disk drive including a base portion, a motor-hub assembly to which at least one disk is coupled, the motor-hub assembly coupled with the base portion. An airflow shroud is also coupled with the base portion. The airflow shroud including an airflow inlet oriented parallel to the disk and an airflow outlet oriented perpendicular to the disk. In so doing, the airflow shroud reduces vibration of a rotating disk in a hard disk drive.

### BRIEF DESCRIPTION OF THE DRAWINGS

FIG. 1 is an isometric view of a hard disk drive in accordance with an embodiment of the present invention.

FIG. 2A is an isometric view of an embodiment of a shroud in accordance with an embodiment of the present invention.

FIG. 2B is an exploded view of the structural components in FIG. 2A in accordance with an embodiment of the present invention.

FIG. 3A is an isometric view of another embodiment of a shroud in accordance with an embodiment of the present invention.

FIG. 3B is an exploded view of the structural components in FIG. 3A in accordance with an embodiment of the present invention.

FIG. 4A is an isometric view of another embodiment of a shroud in accordance with an embodiment of the present invention.

FIG. 4B is an exploded view of the structural components in FIG. 4A in accordance with an embodiment of the present invention.

FIG. 5 is a flow chart of a method for providing an airflow shroud that reduces vibration of a rotating disk in a hard disk drive in accordance with an embodiment of the present invention.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

One embodiment provides a hard disk drive having an airflow shroud. The airflow shroud includes an airflow inlet oriented parallel to a disk and an airflow outlet oriented perpendicular to the disk. In one embodiment, the outlet for the airflow is between the shroud wall and the hard disk drive cover. By changing the outlet location, the airflow shroud reduces vibration of the rotating magnetic disk so there is no drop in performance in terms of reading from or writing to the magnetic disk regardless of whether the hard disk drives are reduced in size, provided with higher RPM operations, or a combination thereof. In other words, in one embodiment the deleterious effects of airflow disturbances, with respect to the shroud outlet, are moved away from the disk and its associated airflow.

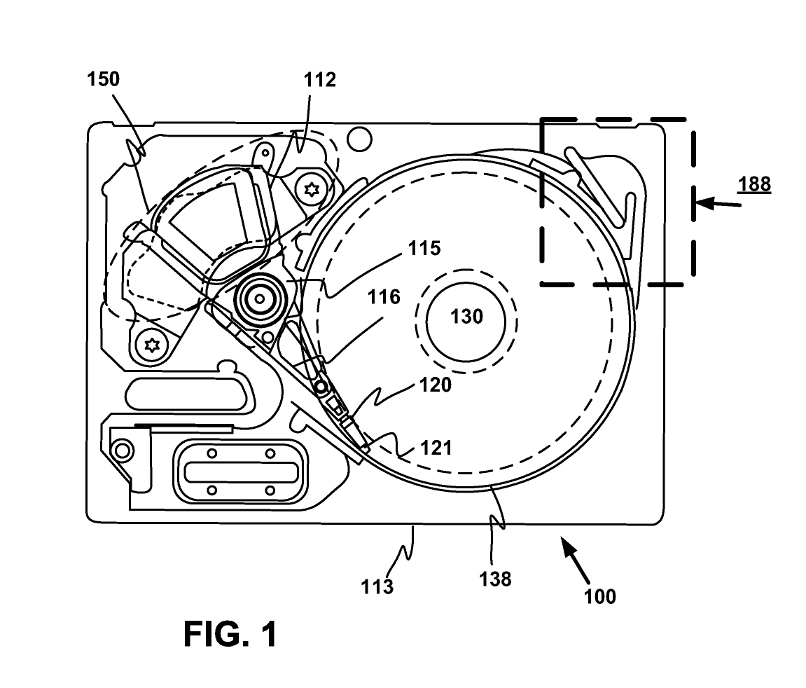

With reference now to FIG. 1, a schematic drawing of one embodiment of an information storage system including a magnetic hard disk file or HDD 100 for a computer system is shown. Although only one head and one disk surface combination are shown, embodiments described herein for one head-disk combination may also be applicable to multiple head-disk combinations.

In general, HDD 100 has an internal base plate 113 and an internal cover (not shown). In one embodiment, internal housing 113 contains a disk pack having at least one media or magnetic disk 138. The disk pack (as represented by disk 138) defines an axis of rotation and a radial direction relative to the axis in which the disk pack is rotatable.

A spindle motor assembly having a central drive hub 130 operates as the axis and rotates the disk 138 or disks of the disk pack in the circumferential direction relative to internal base plate 113. An actuator assembly 115 includes one or more actuator arms 116. When a number of actuator arms 116 are present, they are usually represented in the form of a comb that is movably or pivotally mounted to base/housing 113. A controller 150 is also mounted to internal base plate 113 for selectively moving the actuator arms 116 relative to the disk 138. Actuator assembly 115 may be coupled with a connector assembly, such as a flex cable to convey data between arm electronics (AE) and a host system, such as a computer, wherein HDD 100 resides.

In one embodiment, each actuator arm 116 has extending from it at least one cantilevered integrated lead suspension (ILS) 120. The ILS 120 may be any form of lead suspension that can be used in a data access storage device. The level of integration containing the slider or magnetic head 121, ILS 120, and read/write head is called the Head Gimbal Assembly (HGA).

The ILS 120 has a spring-like quality, which biases or presses the air-bearing surface of slider 121 against disk 138 to cause slider 121 to fly at a precise distance from disk 138. ILS 120 has a hinge area that provides for the spring-like quality, and a flexing cable-type interconnect that supports read and write traces and electrical connections through the hinge area. A voice coil 112, free to move within a conventional voice coil motor magnet assembly is also mounted to actuator arms 116 opposite the head gimbal assemblies. Movement of the actuator assembly 115 by controller 150 causes the head gimbal assembly to move along radial arcs across tracks on the surface of disk 138. FIG. 1 also includes a shroud 188.

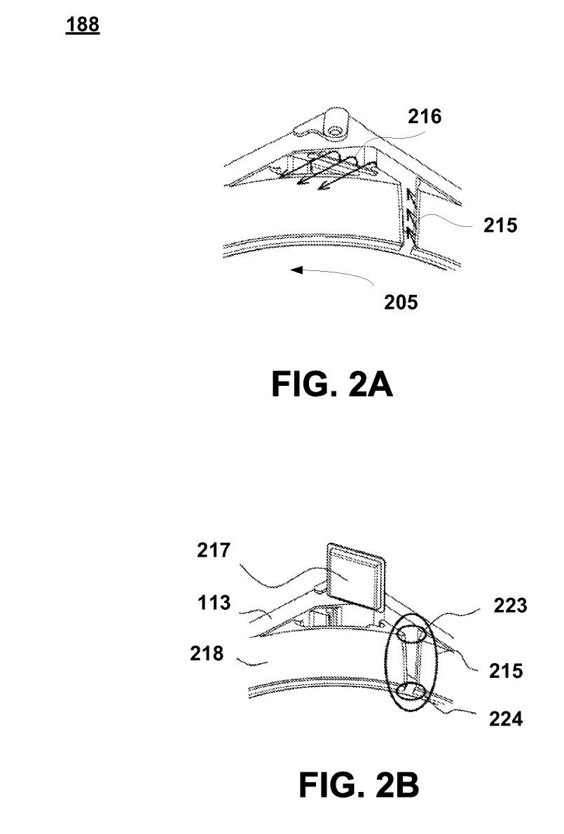

With reference now to FIG. 2A, one embodiment of a shroud 188 is shown in operation. One embodiment of FIG. 2A includes a direction of airflow 205 which is also the direction of rotation of disk 138. One embodiment includes an inlet 215 which is located between the wall of base 113 and the beginning of the shroud 188. FIG. 2A also includes an outlet 216. In one embodiment, outlet 216 is located between the top of shroud 188 and the cover of the hard disk drive.

In general, airflow 205 defines the direction of the airflow with respect to shroud 188 when disk 138 is rotated. The airflow 205 produced by the rotation of disk 138 includes air which enters from inlet 215 is then directed to the top of shroud 188 and escapes via outlet 216 between shroud 188 and the top cover.

With reference to FIG. 2B, one embodiment of the components of shroud 188 are shown. In FIG. 2B, shroud 188 is fixedly coupled with base 113. In one embodiment, shroud surface 218 follows the shape of the outer periphery of disk 138. In one embodiment, a filter 217 is disposed between inlet 215 and outlet 216. In one embodiment, inlet 215 is formed with slit-shaped passage that runs from the magnetic disk facing surface 218.

In one embodiment, grooves for holding filter 217 are formed in base 113 and in the opposite side of shroud surface 218. Single inlet 215 is formed at the front most portion of shroud 188 with respect to the direction of rotation of disk 138. A lower portion 224 and upper portion 223 are provided for clarity. In general, lower portion 224 is located proximal to base 113 while upper portion 223 is located proximal to the hard disk drive cover.

In one embodiment of FIG. 2B, the air which has passed through the upper side of filter 217 is prevented from coming back into the airflow around disk 138. Instead, outlet 216 lets the air escape between base 113, shroud 188 and the top cover. In so doing, a disturbance to the flow of air around disk 138 caused by the air returning to the flow after passing through filter 217 is relocated. Thus, a reduction in vibration of the rotating disk 138 is realized, when compared with a filtered airflow returned to a location closer to the rotating disk 138.

It is also known that vibration of the magnetic disk can be better reduced the narrower the gap between the magnetic disk and the shroud. This is because narrowing the gap makes it possible to reduce the amount of air flowing perpendicular to the magnetic disk surface.

In one embodiment, shroud 188 and base 113 are formed as a single piece. For example, they may be molded, cast, milled, or the like. In one embodiment, when the formed base 113 and shroud 188 is removed from the mold, the length of the cutaway in the direction of rotation of the magnetic disk needs to be such that the length at upper portion 223 is longer than the length at lower portion 224 in order to prevent damage to the completed base 113.

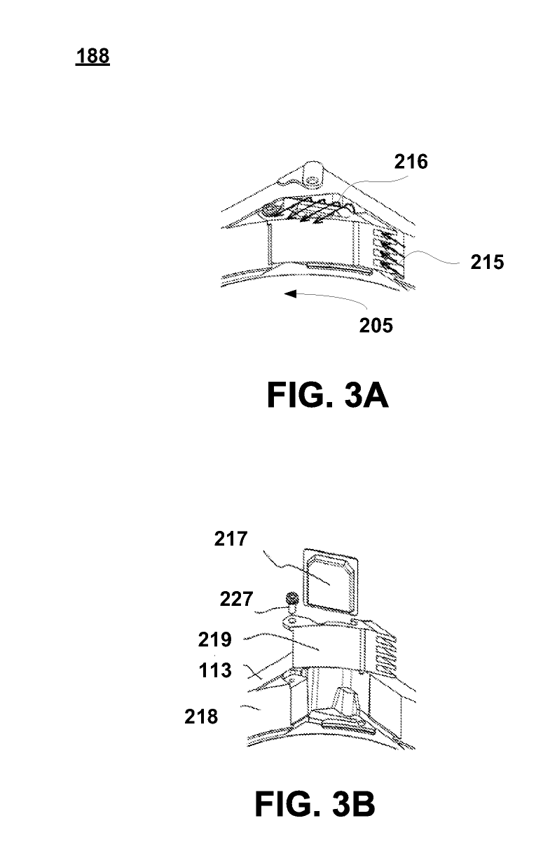

With reference now to FIG. 3A, an isometric view of another embodiment of shroud 188 is shown. In FIG. 3A, two part of shroud 188 are formed. First part 219 of FIG. 3B is formed as a separate member while a second part 218 of shroud 188 is fixedly coupled with base 113. FIG. 3A shows the flow of air produced when disk 138 is rotated. FIG. 3B is an exploded view of the structural components in FIG. 3A.

In FIG. 3B, one embodiment of shroud 188 in which first part 219 is formed as a separate member that is secured to base 113 by retaining device 227 to form the whole shroud 188. In one embodiment, retaining device 227 is a screw. However, the technology is well suited to retaining device 227 being a pin, bolt, or the like.

Similar to FIG. 2B, a groove for fixing filter 217 is provided in base 113 and in the back side of first part 219. Slits are provided on the first part 219 of shroud 188 at inlet 215 along the direction of rotation of the magnetic disk.

In FIG. 3B, similar to FIG. 2B, no outlet slits are provided in the shroud surface 218 or the surface portion of first part 219. Instead, outlet 216 is provided between the top of shroud 188 and the cover of the hard disk drive. In so doing, air which has passed through filter 217 is prevented from coming close to the disk 138. Therefore, the same effect as described with regard to FIG. 2B is achieved. In one embodiment, the structure of shroud 188 of FIGS. 3A and 3B includes no deep recess around the area where filter 217 is secured. Therefore the base has a relatively simple shape and the structure can be easily produced.

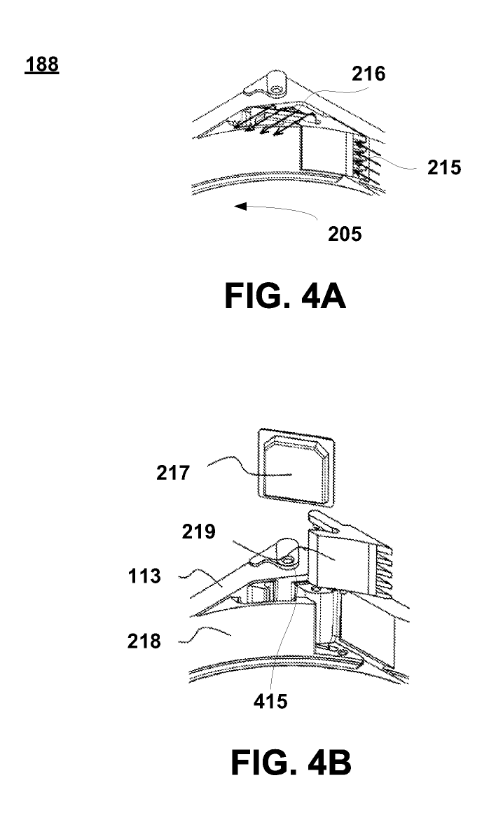

With reference now to FIG. 4A, one embodiment of shroud 188 is shown. In addition, FIG. 4A includes an arrow indicating the direction of travel of airflow 205 which is produced when disk 138 is rotated. FIG. 4A includes an inlet 215 and an outlet 216 similar to those described in FIGS. 2A and 3A.

With reference now to FIG. 4B, an exploded view of the structural components in FIG. 4A are shown in accordance with one embodiment. In one embodiment, shroud 188 of FIG. 4B includes a first part 219 which includes inlet 215 and a portion of the disk 138 facing shroud surface and a shroud surface 218 fixedly coupled with base 113. In one embodiment, the surface area of the part of the shroud surface formed by first part 219 is smaller than the first part 219 of FIG. 3A. In so doing, further reduction in the disturbance of the air and reduce vibration of disk 138 may be realized.

In one embodiment, first part 219 of shroud 188 is fixed to base 113 with a retaining device such as a pin which may fit into a hole 415 provided in base 113. In one embodiment, there is no play between the retaining device and hole 415, and therefore it is possible to improve the degree of accuracy with which the separate member is attached to the base. In one embodiment, by utilizing a pin in a hole instead of a screw as the retaining device, costs can be reduced and assembly time may also be reduced.

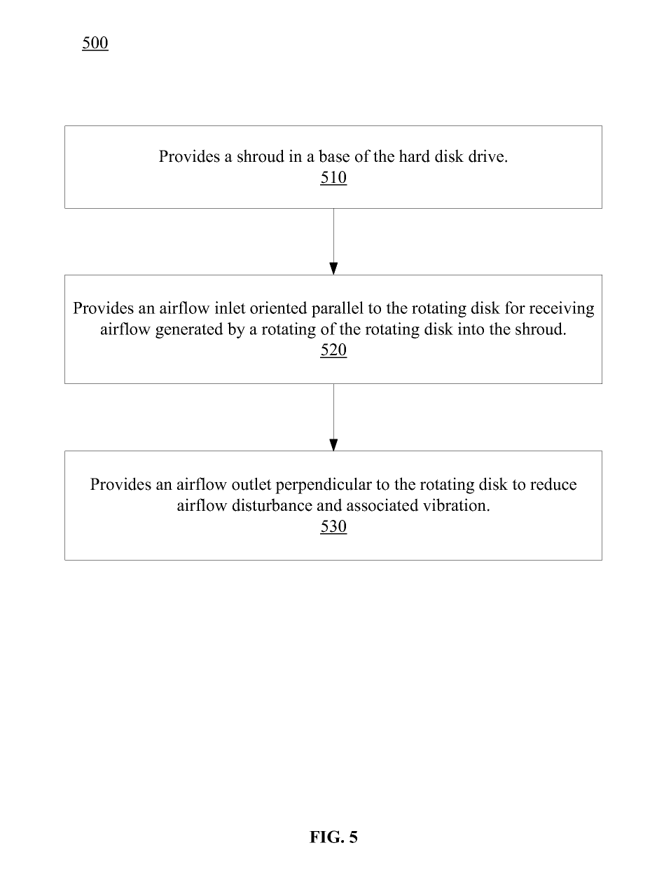

With reference now to FIG. 5, a flowchart of a method for providing an airflow shroud 188 that reduces vibration of a rotating disk 138 in a hard disk drive 100 is shown in accordance with an embodiment of the present invention.

At 510 of FIG. 5 as illustrated in FIG. 1, one embodiment provides a shroud 188 in a base 113 of the hard disk drive 100. In general, shroud 188 is utilized to filter the air inside hard disk drive 100. For example, to remove dust or other particulates before they can detrimentally affect the operation of hard disk drive 100.

In one embodiment, shroud 188 is located in a corner of base 113 of hard disk drive 100. In addition, shroud 188 includes a shroud surface 218 designed to follow a shape of an outer periphery of the disk 138 in hard disk drive 100. In one embodiment, shroud 188 is formed in conjunction with base 113 such that shroud 188 is fixedly coupled with base 113.

In another embodiment, only a portion of shroud 188 is formed in conjunction with base 113 and fixedly coupled therewith. In addition, a mounting location such as hole 415 is also formed in base 113 for mounting a second portion of shroud 188 which may be removably coupled with base 113.

At 520 of FIG. 5 and with reference to FIGS. 2A through 4B, one embodiment provides an airflow inlet 215 oriented parallel to the rotating disk 138 for receiving airflow 205 generated by the rotating disk 138 into shroud 188.

At 530 of FIG. 5 and with reference to FIGS. 2A through 4B, one embodiment provides an airflow outlet 216 perpendicular to the rotating disk 138 to reduce airflow disturbance and associated vibration. In one embodiment, the airflow outlet 216 is located between the top of shroud 188 and a top cover of hard disk drive 100.

In one embodiment, a filter element 217 is removably coupled with shroud 188. In one embodiment, filter element 217 is located between the airflow inlet 215 and the airflow outlet 216 of shroud 188.

Various embodiments of the present invention are thus described. While the present invention has been described in particular embodiments, it should be appreciated that the present invention should not be construed as limited by such embodiments, but rather construed according to the following claims.

What is claimed is:

1. A hard disk drive (HDD) comprising:
a base portion;
a motor-hub assembly to which at least one disk is coupled, the motor-hub assembly coupled with the base portion; and
an airflow shroud coupled with the base portion, the airflow shroud comprising:
an airflow inlet oriented parallel to the disk; and
an airflow outlet oriented perpendicular to the disk.

2. The HDD of claim 1 further comprising:
a shroud surface of the airflow shroud comprising a shape of an outer periphery of the rotating disk in the hard disk drive.

3. The HDD of claim 1 wherein the airflow inlet is configured to receive airflow generated by a rotation of the disk.

4. The HDD of claim 1 wherein the airflow inlet comprises at least one vertical slit.

5. The HDD of claim 1 wherein the airflow inlet comprises a comb-shaped horizontal inlet.

6. The HDD of claim 1 wherein the airflow outlet is configured to reduce airflow disturbance and associated vibration caused by the outflow of air from the shroud.

7. The HDD of claim 1 wherein the shroud is formed with the base portion and fixedly coupled with the base portion.

8. The HDD of claim 1 further comprising:
a mounting location for the shroud formed with the base portion and fixedly coupled with the base portion; and
an additional shroud portion added to the mounting location, the additional shroud portion removably coupled with the base portion.

9. The HDD of claim 1 wherein the airflow outlet is located between the top of the shroud and a top cover of the hard disk drive.

10. The HDD of claim 1 further comprising:
an airflow filter removably coupled with the shroud, the airflow filter between the airflow inlet and the airflow outlet of the shroud.

11. A method for providing an airflow shroud that reduces vibration of a rotating disk in a hard disk drive caused by the outflow of air from the shroud, the method comprising:
providing a shroud in a base of the hard disk drive;
providing an airflow inlet oriented parallel to the rotating disk for receiving airflow generated by the rotating disk into the shroud; and
providing an airflow outlet perpendicular to the rotating disk to reduce airflow disturbance and associated vibration.

12. The method of claim 11 further comprising:
providing the shroud in a corner of a base portion of the HDD.

13. The method of claim 11 further comprising:
forming the shroud surface to follow a shape of an outer periphery of the rotating disk in the hard disk drive.

14. The method of claim 11 further comprising:
forming the shroud during the forming of the base, the shroud fixedly coupled with the base.

15. The method of claim 11 further comprising:
forming the mounting location for the shroud during the forming of the base, the mounting location fixedly coupled with the base; and
adding an additional shroud portion to the mounting location, the additional shroud portion removably coupled with the base.

16. The method of claim 11 further comprising: removably coupling a filter element with the shroud, the filter element located between the airflow inlet and the airflow outlet of the shroud.

17. The method of claim 11 further comprising:
providing the airflow outlet between the top of the shroud and a top cover of the hard disk drive.

18. A hard disk drive (HDD) comprising:
a base portion for providing coupling points for components and sub-assemblies of the hard disk drive;
a motor-hub assembly to which at least one disk is coupled allowing rotation of the disk about an axis approximately perpendicular and centered to the disk, the motor-hub assembly coupled with the base portion; and
an airflow shroud coupled with the base portion, the airflow shroud comprising:
an airflow inlet oriented parallel to the rotating disk for receiving airflow generated by a rotating of the rotating disk; and
an airflow outlet oriented perpendicular to the rotating disk to reduce airflow disturbance and associated vibration caused by the outflow of air from the shroud.

19. The HDD of claim 18 further comprising:
a shroud surface of the airflow shroud comprising a shape of an outer periphery of the rotating disk in the hard disk drive.

20. The HDD of claim 18 wherein the shroud is formed with the base housing and fixedly coupled with the base portion.

21. The HDD of claim 18 further comprising:
a mounting location for the shroud formed with the base portion and fixedly coupled with the base portion; and
an additional shroud portion added to the mounting location, the additional shroud portion removably coupled with the base portion.

22. The HDD of claim 18 wherein the airflow outlet is located between the top of the shroud and a top cover of the hard disk drive.

23. The HDD of claim 18 further comprising:
an airflow filter removably coupled with the shroud, the airflow filter between the airflow inlet and the airflow outlet of the shroud.
